(19) United States
(12) Patent Application Publication
(10) Pub. No.: US 2008/0181756 A1
(43) Pub. Date: Jul. 31, 2008

(54) Pole-handling attachment for an end loader

(76) Inventor: James Moffitt, Bushnell, FL (US)

Correspondence Address: LITMAN LAW OFFICES, LTD., P.O. BOX 15035, CRYSTAL CITY STATION, ARLINGTON, VA, 22215, US

(21) Appl. No.: 11/698,039

(22) Filed: Jan. 26, 2007

(51) Int. Cl. B66C 1/42; E02F 3/96

(52) U.S. Cl. 414/729; 37/406

(57) ABSTRACT

The pole-handling attachment for an end loader is installed upon the machine (e.g., skid-steer machine, tractor and bucket, etc.) in place of the conventional bucket, for manipulating poles, posts, and other elongate columns by a single machine operator. The attachment includes a base frame having opposite fixed ends, and a sliding pole clamp assembly therebetween. A series of arms extend from one of the fixed ends and the sliding assembly for grasping the pole therebetween. The end loader tilt mechanism is adjusted to orient the arms normal to the pole, and the machine is maneuvered to position the arms on opposite sides of the pole. The slide assembly is then moved to clamp the pole against the opposite fixed end, and the machine maneuvered to position the pole as required. The base frame may include a pivot mechanism to allow the frame to rotate, for greater versatility.

### BACKGROUND OF THE INVENTION

1. Field of the Invention

The present invention relates generally to powered attachments for earthmoving equipment and the like. More specifically, the present invention comprises a pole-handling attachment for an end loader (e.g., skid-steer loader, tractor and bucket, etc.) wherein the bucket is removed and the attachment installed in its place. The attachment allows the end loader to pick up relatively tall and heavy poles, posts, and the like, and manipulate them for installation or removal from a site.

2. Description of the Related Art

The setting of tall, heavy poles in the ground is a common operation in many construction projects. Such poles are used not only for heavy fencing and barrier construction, but also for pole buildings and the like, as well as for supports for overhead wires and cables, etc.

Conventionally, such poles have been handled using end loader equipment, e.g., tractors equipped with hydraulically actuated end loader buckets, skid steer and tracked type vehicles equipped with such buckets, etc. For the placement of a pole or post in a previously prepared installation hole, the pole is chained to the bucket using the conventional hooks usually provided on such buckets for such purposes, and the vehicle is maneuvered to position the pole as desired.

However, this cannot be accomplished solely by the vehicle operator maneuvering the vehicle and bucket from the operator's position of the vehicle. At least one other individual (and perhaps more, depending upon the size of the pole or post) is needed to attach the chain around the post and to the bucket, maneuver and position the pole as it is being carried by the end loader vehicle, and detach the chain from the pole and bucket once the pole has been properly set. The same need for at least one person in addition to the end loader operator also applies when poles or posts are removed from the site of a previous installation.

As a result, various powered mechanisms have been developed for handling elongate poles, columns, and the like, by a single operator operating an end loader or other suitable vehicle. An example of such is found in Japanese Patent No. 02-163,295, published on Jun. 22, 1990. This publication describes (according to the drawings and English abstract) a pole handling mechanism that replaces the forks of a forklift. The mechanism includes clamps for securing about the pole or post, and a rotary mechanism for rotating the pole or post in a plane parallel to the mast of the forklift.

None of the above inventions and patents, either singly or in combination, is seen to describe the instant invention as claimed. Thus, a pole-handling attachment for an end loader solving the aforementioned problems is desired.

### SUMMARY OF THE INVENTION

The pole-handling attachment for an end loader is attached to the end loader (skid-steer machine, tractor and bucket, etc.) after removal of the conventional bucket for manipulating a pole, post, or other elongate column as required. The term “pole” is generally used throughout the present application to describe the elongate article the pole-handling attachment is configured to handle, with the term “post” being used interchangeably therewith but generally implying an article having a shorter length than a pole. The pole-handling attachment is capable of handling poles, posts, and similar elongate columns of any practicable length.

The pole-handling attachment comprises a frame that has opposite fixed actuator and clamp end members and a laterally sliding pole clamp member therebetween. The sliding member is actuated by a telescopically extending and retracting strut, e.g., a hydraulic ram, a screw jack, etc., to move selectively toward or away from the fixed clamp end member in order to selectively clamp a pole or the like between the clamp end member and the sliding member for handling as desired.

A plurality of extension tines are adjustably secured to the ends of the protruding pole clamp arms, which extend from the fixed clamp end member and the sliding member. These extension tines are adjusted in or out relative to the pole clamp arms to fit the thickness of the pole or post to be handled by the device. To pick up a pole resting generally horizontally upon the surface, the bucket tilt control of the end loader is operated to tilt the pole-handling mechanism forward so that the pole clamp arms are generally vertical, i.e., normal to the elongate axis of the pole. The end loader is then maneuvered to position the pole or post between the extension tines, and the sliding member is clamped securely against the pole or post by means of the telescoping strut to clamp the pole securely between opposite clamp arms and their extensions. An additional stabilizing arm may be provided to prevent the pole from pivoting between the clamps during maneuvering.

Once the above has been accomplished, the conventional bucket controls of the end loader are operated to lift the mechanism and tilt it back to position the pole to a substantially vertical orientation. The end loader and its pole load may then be maneuvered to the installation site for the pole, whereupon the controls are operated to lower the pole into the previously prepared hole and hold the pole upright until it is anchored in the ground. The above procedure is reversed to remove a pole from a previous in-ground installation.

An alternative embodiment includes a mechanism for selectively pivoting the pole-handling frame about an axis normal to the pole or post held therein, i.e., normal to the attachment or mounting plate securing the device to the end loader. This pivoting mechanism allows the pole to be pivoted from the vertical to the horizontal, or to any angle therebetween, in a plane normal to the mounting plate of the mechanism, with the orientation of the rotational plane depending upon the tilt of the mechanism as driven by the conventional end loader bucket controls.

These and other features of the present invention will become readily apparent upon further review of the following specification and drawings.

### BRIEF DESCRIPTION OF THE DRAWINGS

FIG. 1 is an exploded perspective view of a pole-handling attachment for an end loader according to the present invention, illustrating its various components.

FIG. 2 is a side elevation view in section of the pole-handling attachment of the present invention, illustrating the pole alignment strut of the device and its operation.

FIG. 3 is a detailed perspective view illustrating the optional extension link between the actuating rod and attach point of the slide in a pole-handling attachment for an end loader according to the present invention.

FIG. 4 is a front elevation view of an end loader equipped with the pole-handling attachment according to the present invention, shown picking up a pole by means of the pole-handling attachment.

FIG. 5 is an environmental, left side elevation view of a pole-handling attachment for an end loader according to the present invention, showing a pole lifted from the surface by the pole-handling attachment.

FIG. 6 is an environmental left side elevation view of a pole-handling attachment for an end loader according to the present invention, showing the pole elevated to an intermediate angle.

FIG. 7 is an environmental left side elevation view of a pole-handling attachment for an end loader according to the present invention, showing the pole elevated to a substantially vertical orientation.

FIG. 8 is a schematic right side elevation view of an alternative embodiment of a pole-handling attachment for an end loader according to the present invention having a selectively adjustable pivot for tilting the mechanism laterally.

FIG. 9 is a diagrammatic section view along lines 9-9 of FIG. 8.

Similar reference characters denote corresponding features consistently throughout the attached drawings.

### DETAILED DESCRIPTION OF THE PREFERRED EMBODIMENTS

The present invention is a pole-handling attachment for end loader machines, e.g., tractors having end loader bucket attachments, skid-steer machines with buckets, etc. The end loader buckets of such machines are conventionally operated by a series of hydraulic controls and are conventionally removable, allowing other powered or unpowered attachments to be installed in place of the removed buckets. Such attachments may be configured for handling a wide variety of different tasks, e.g., plowing snow, pavement sweeping, relatively light earthmoving operations, etc., depending upon the specific attachment.

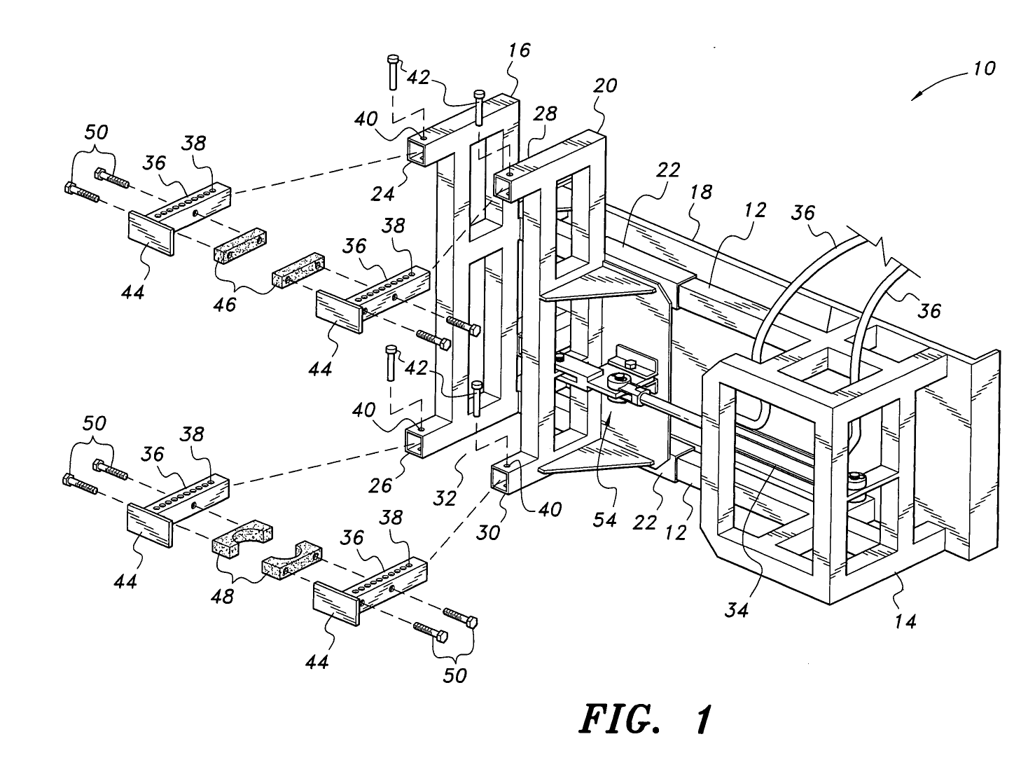

FIG. 1 of the drawings provides an exploded perspective view of a first embodiment 10 of a pole-handing attachment for an end loader according to the present invention, configured for handling and manipulating relatively large elongate objects, such as poles, posts, columns, etc. The pole-handling attachment 10 includes a substantially rectangular base frame 12 having a fixed actuator end 14, i.e., the end to which the powered actuator for the clamp is anchored, and an opposite fixed clamp end 16, i.e., the end to which clamping pressure is applied to hold a pole or the like thereagainst. The two ends 14 and 16 are generally normal to the base frame 12 and include rearwardly disposed extensions attaching to an end loader attachment plate 18, to space the base frame 12 somewhat away from the attachment plate 18 to allow clearance for the slide member, discussed below. The attachment plate 18 includes conventional fittings (not shown) on the rear surface thereof to enable the plate 18, and thus the pole-handling attachment 10, to be removably secured quickly and easily to the conventional bucket attachment fittings of an end loader machine.

A slide assembly 20 is installed upon the two elongate parallel members comprising the main portion of the base frame 12 by corresponding sleeves 22, from which the remainder of the slide assembly structure extends. The slide assembly 20 is thus free to move laterally between the two ends 14 and 16 of the base frame 12, toward and away from the fixed clamp end 16 of the attachment 10. The clamp end 16 and slide 20 each extend somewhat above the frame 12 in order to provide a greater span between the respective ends of each component. The two opposed ends of the clamp end assembly 16 include parallel first and second clamp arms 24 and 26 extending normal to the base frame 12, and the two opposed ends of the slide assembly 20 include similar first and second slide arms, respectively 28 and 30, which also extend normal to the base frame 12. The four arms 24 through 30 are substantially parallel to one another in a rectilinear array and define an adjustable pole clamping zone 32 therebetween.

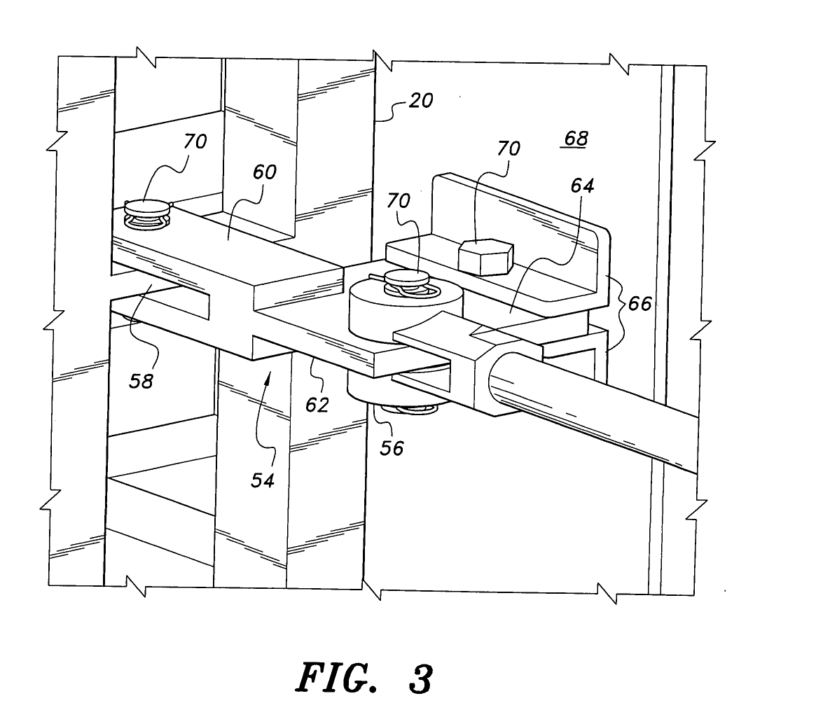

The slide assembly 20 is actuated by a double acting linear actuator 34 having an anchor end pinned to the actuator end frame assembly 14 and an opposite actuator strut or rod end secured to the slide assembly 20. The actuator rod is shown attached to an intermediate link, which is, in turn, attached to the slide assembly structure 20. This intermediate link is shown in further detail in FIG. 3, and explained further below in the discussion of that drawing. Alternatively, the strut or rod of the actuator 34 could be secured directly to the slide assembly 20, depending upon the required travel of the slide assembly 20 and the length of travel of the actuator rod. The actuator 34 may comprise a conventional double acting hydraulic strut, which receives hydraulic pressure via a pair of hydraulic lines 36 controlled by a conventional auxiliary hydraulic control on the end loader machine. Alternatively, the actuator 34 may comprise a conventional screw jack assembly powered by an electric or hydraulic motor, as known in the art.

Each of the four hollow arms 24 through 30 of the fixed clamp end structure 16 and slide assembly 20 may include a telescopically adjustable extension tine 36 removably installed therein. Four such tines 36 are shown separated from the arms 24 through 30 in FIG. 1. Each of the tines 36 preferably includes a series of attachment holes 38 formed therethrough, with single attachment passages 40 provided through the arms 24 through 30. The tines 36 may be pinned in place in their respective arms by corresponding pins 42, with the pins 42 preferably including conventional tethers to prevent their loss and locking means (spring loaded detent balls, etc.) to hold the pins 42 in their installed positions.

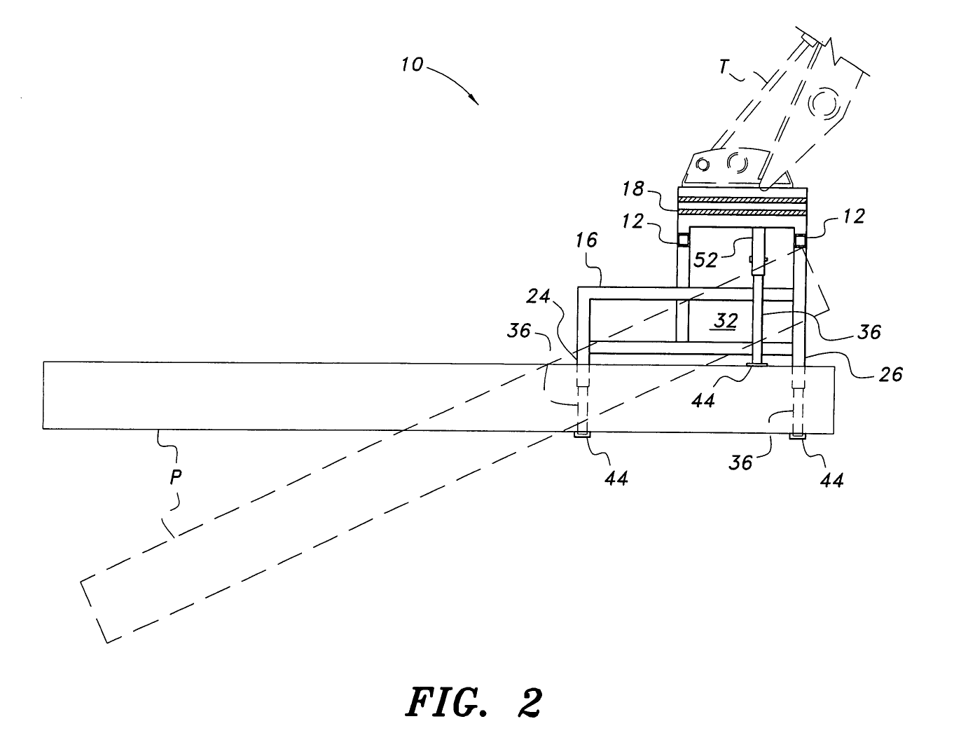

Each of the tines 36 has a pole grasping shoe 44 affixed across the distal end thereof, with the shoes 44 each having a width greater than the width or diameter of the tines 36. The wider ends of the shoes 44 insert beneath the edges of a pole or the like gripped between the arms 24 through 30 and their respective tines 36, to prevent the pole from slipping past the distal ends of the tines 36. The tines 36 are adjustably installed in their respective arms 24 through 30 to provide a throat depth, i.e., the dimension between the pole grasping shoes 44 and the backs of the clamp end frame 16 and slide frame assembly 20, corresponding to the diameter or thickness of the pole to be gripped therebetween. (Additional adjustment means for the thickness of the pole are illustrated in FIG. 2, and discussed further below.)

Preferably, the various components described above are constructed primarily of steel tubing having a square or rectangular cross section. Other cross-sectional shapes may be used as desired. As steel has a relatively low coefficient of surface friction, the clamping pressures required to secure a pole between the fixed clamping end 16 and the slide frame assembly 20 of the device may be relatively high, possibly damaging a pole of relatively soft material (soft wood, etc.) clamped therebetween. Accordingly, supplemental gripping blocks 46, 48 may be removably installed upon the facing sides or surfaces of the tines 36. The first or upper blocks 46 have flat pole contact surfaces and are configured for bearing against the flat surface of a square or rectangular pole or the like. The second or lower blocks 48 have concave semicircular pole contact surfaces, configured to bear against a pole having a round cross section. It will be seen that the two different types of blocks 46, 48 are illustrated in a single installation in FIG. 1 for expediency, and that normally only a single type of block would be used when manipulating a given pole configuration. Moreover, other shapes corresponding to the cross-sectional shapes of the poles to be handled may be provided for the contact faces of the blocks. The blocks 46, 48 may be secured to the respective tines 36 by through bolts 50 engaging conventional threaded inserts (not shown) within the blocks, or by other suitable fasteners.

The relatively low friction provided by the steel structure of the end clamp frame assembly 16 and slide frame assembly 20 has been noted above. Even when gripping blocks having relatively high surface friction coefficients are installed, there still may be a tendency for a pole to shift between the frames 16 and 20, particularly in the case of a relatively long pole where the center of gravity of the pole is located at some distance from the handling attachment 10. FIG. 2 of the drawings illustrates such a situation. In FIG. 2, the pole-handling attachment 10 is shown in section, with the actuator anchor end 14 and slide assembly 20 not shown in FIG. 2. It will also be noted that the handling attachment 10 of FIG. 2 has been tilted or rotated about 90 degrees from its orientation in FIG. 1 by the tilt actuators T conventionally provided with end loader bucket machinery. This orients the end loader attachment plate 18 and the plane defined by the base frame members 12 generally horizontal in FIG. 2.

A relatively heavy and elongate pole P is shown being held in a generally horizontal orientation by the pole-handling attachment 10, with the first and second clamp end arms 24 and 26 and their extension tines 36 oriented normal to the elongate axis of the pole P, i.e., generally vertically. The center of the pole P is clearly located well beyond the pole-handling apparatus 10 in FIG. 2 and, as a result, the pole P will tend to pivot or swivel about the pole grasping shoe 44 of the tine 36 extending from the first arm 24, as shown by the broken line position of the pole P in FIG. 2.

Accordingly, the pole-handling attachment 10 preferably includes an unbalanced pole brace arm 52. The brace arm 52 is located within a clamping zone 32 defined by the four arms 24 through 30 and their extension tines 36, i.e., between the plane defined by the clamping arms 24, 26 and the plane defined by the opposite slide arms 28, 30. This positions the brace arm 52 over the end of the pole P in its horizontal orientation, as shown in solid lines in FIG. 2, rather than beside the pole, as are the clamping arms 24, 26 and their extension tines 36. Thus, the distal end of the brace arm 52 (and installed extension tine 36 and shoe 44) bears against the upper surface of the pole P, preventing it from rising. The lower edge or surface of the pole P is captured by the protruding edges of the grasping shoes 44 of the tines 36 extending from the first clamping arm 24 and the corresponding first slide arm 28 (not shown in FIG. 2). Thus, the pole P is restrained from pivoting within the pole-handling attachment 10 when in a horizontal orientation by the opposed grasping shoes 44 extending from the first clamp arm 24 and first slide arm 28, and the opposed shoe 44 and tine 36 bearing against the upper surface of the pole P and extending from the brace arm 52.

The pole-handling attachment 10 may be limited in its maximum width in accordance with the width of the end loader equipment with which it is to be used, and/or in accordance with other limitations (e.g., road width regulations, gate and garage doorway dimensions, etc.). Such a width limit, in combination with the travel required of the slide assembly 20 for gripping relatively wide or large diameter poles and the like, may limit the length of the linear actuator 34 that may be installed in the pole-handling attachment 10. If a shorter actuator must be used, the maximum extended length of the actuator may not be sufficient to move the slide assembly 20 sufficiently close to the clamp end frame assembly 16 to grip a relatively small width or diameter pole.

Accordingly, the pole-handling attachment 10 may include an extension link 54 removably installed between the distal end 56 of the actuator pushrod or strut and the actuator attachment point 58 of the slide frame assembly 20. This link 54 is shown generally in FIG. 1 of the drawings, and is shown in greater detail in FIG. 3. The extension link 54 has a generally “L” shaped configuration, with a slide frame attachment fork 60 at one end of one leg and an actuator strut fork attachment plate 62 opposite the slide frame attachment fork 60. A second leg extends from the actuator strut fork attachment plate 62 and terminates in an extension link stabilizer plate 64, which is removably secured between a pair of extension link attachment plates 66 extending from the base plate 68 of the slide frame assembly 20. The stabilizer plate 64 serves to prevent the extension link 54 from becoming misaligned between the actuator strut end 56 and the actuator attachment point 58 of the slide frame assembly 20 when compressive force is applied to the slide frame by means of the actuator 34. The extension link 54 is quickly and easily removed by removing the various pins and/or bolts 70 comprising the slide frame attachment pin, actuator strut attachment pin, and stabilizer plate attachment pin or bolt, and securing the actuator strut end 56 directly to the actuator attachment point 58 of the slide frame 20 by one of the pins or bolts 70. This allows a greater span or gap for the clamping zone 32 between the slide frame 20 and clamp frame end 16, for poles, posts, and the like having larger cross-sectional dimensions.

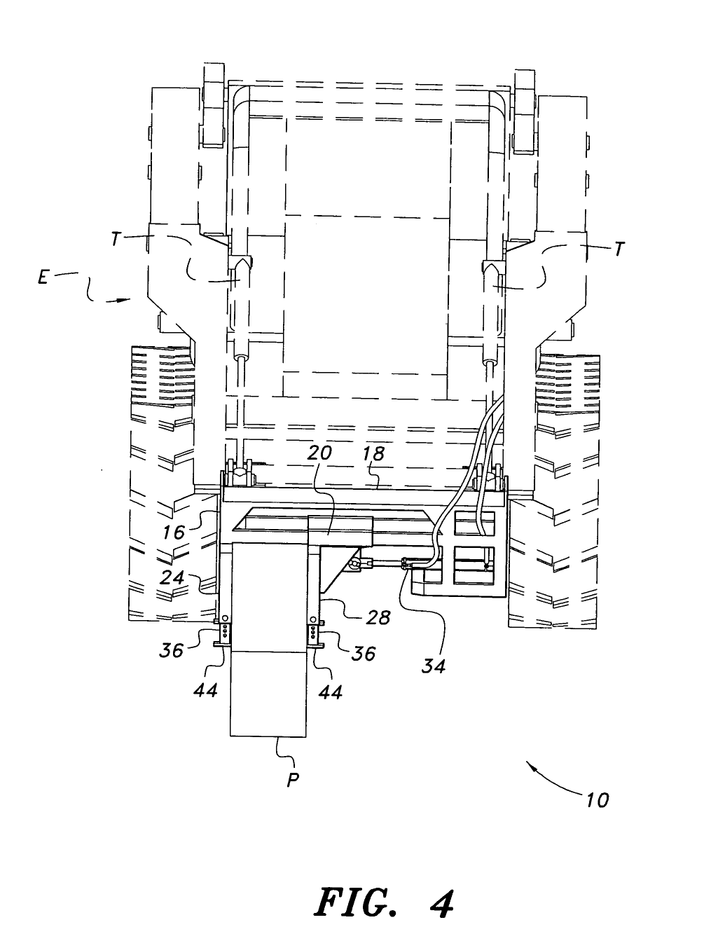

FIGS. 4 through 7 illustrate the operation of the pole-handling attachment 10 with a skid-steer type end loader E to which the attachment 10 has been attached. While a conventional skid-steer machine E is illustrated in broken lines in FIGS. 4 through 7, it will be seen that the attachment 10 may be used with any type of end loader machine to which an end loader bucket may be removably attached. FIG. 4 is a front elevation view of the end loader E with the pole-handling attachment 10 installed thereon, shown as it would be maneuvered to pick up a relatively wide pole or post P. The conventional bucket tilt control of the end loader E is manipulated to extend the tilt actuator struts T of the machine, thus tilting the attachment 10 to the orientation shown in FIG. 4, with the attachment plate 18 oriented substantially horizontally and the clamp arms and slide arms oriented substantially vertically, the first clamp arm 24 and first slide arm 28 being visible in the front elevation view of FIG. 4.

The extension tines 36 of the four clamp and slide arms 24 through 30 have been adjusted within the hollow arms to accommodate the width or thickness of the pole or post P, and the linear actuator 34 has been operated to push the slide frame 20 against the side of the pole P, thus gripping the pole P securely between the slide frame 20 and the opposite clamp end 16. The pole-grasping shoes 44 at the distal ends of the extension tines 36 have their facing lateral ends or edges caught beneath the pole P, thus capturing the pole P between the four arms 24 through 30 and their extension tines 36 with their pole grasping shoes 44. The end of the pole P between the second arms 26 and 30, i.e., that end closest to the end loader E, is prevented from pivoting upwardly from the weight of the opposite extended portion of the pole by means of the pole brace arm 52 and any extension tine 36 installed therein, as shown in FIG. 2 and discussed in detail further above.

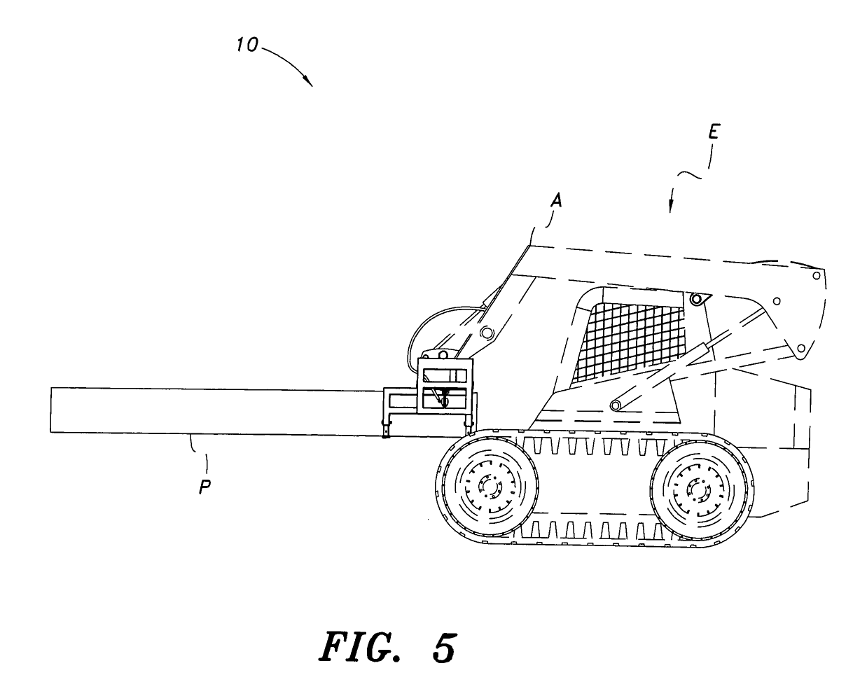

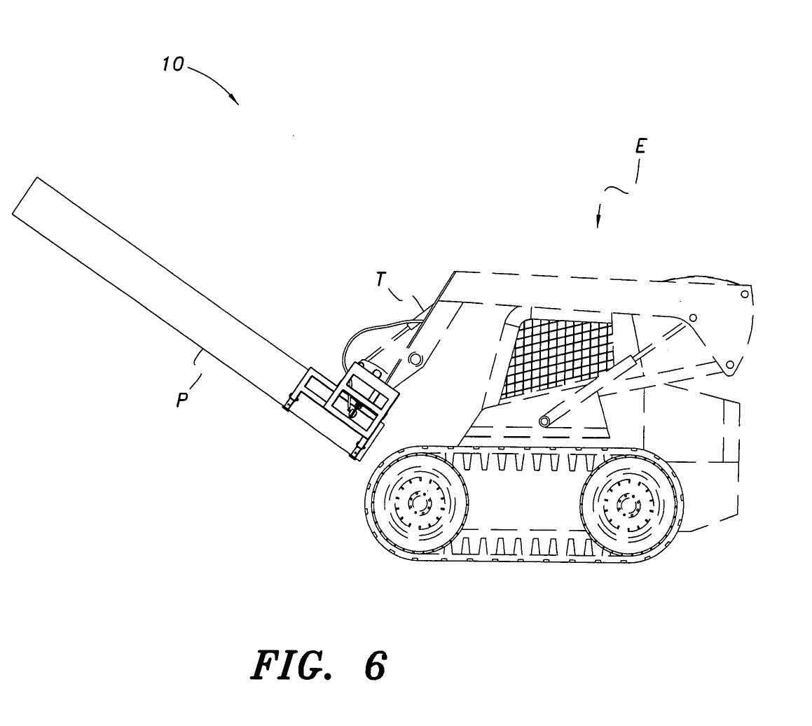

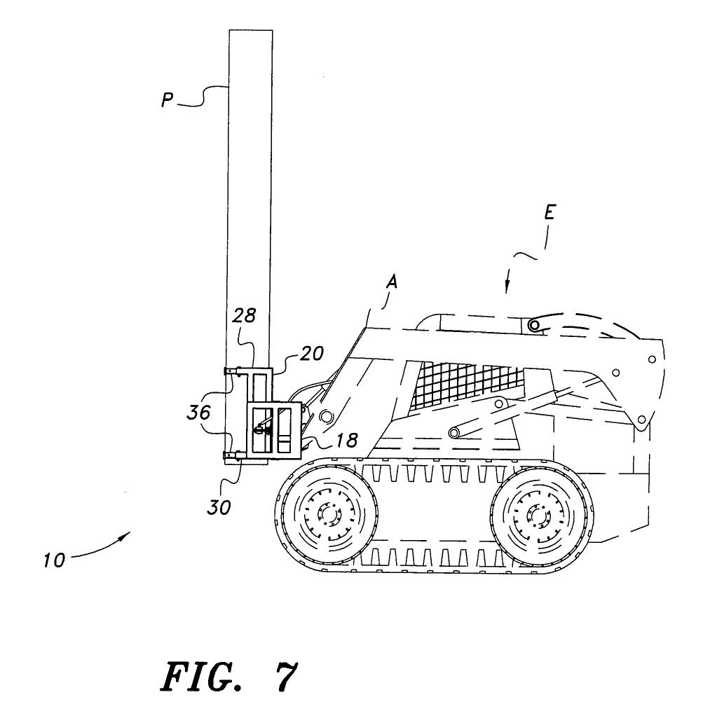

FIG. 5 of the drawings provides a left side elevation view of the pole-handling attachment 10 in which the bucket lift arms A of the end loader E have been actuated to lift the attached pole-handling apparatus 10 and the pole P secured therein above the underlying surface. The pole P is still oriented substantially horizontally in this view, as the pole-handling attachment 10 is still tilted forwardly, as in the orientation shown in the front view of FIG. 4 and the sectional side elevation view of FIG. 2. However, the raising of the pole-handling attachment 10 and its captured pole P above the surface provides clearance for further manipulation of the pole by the attachment 10, as shown in FIGS. 6 and 7.

In FIG. 6, the pole-handling attachment 10 has been rotated or tilted in a clockwise rotational direction in comparison to the orientation shown in FIGS. 2, 4, and 5 by means of the conventional bucket tilt actuator struts T of the end loader E, thus orienting the pole P at an intermediate angular orientation between the horizontal and vertical. This is an intermediate position passed through while bringing the pole P from a horizontal to a vertical position. However, it may be desirable to use such an intermediate position for maneuvering the pole P beneath relatively low obstructions, installing the pole P as a diagonal brace, etc. The pole-handling attachment 10 is capable of positioning the pole P in such an orientation by means of the conventional end loader controls as a finally installed orientation, if so desired.

FIG. 7 provides a left side elevation view showing the pole-handling attachment 10 tilted to the orientation shown in FIG. 1, i.e., with the attachment plate 18 oriented in the vertical plane and the various slide and clamp end arms and their extensions, e.g., the first and second slide arms 28 and 30 and corresponding extensions 36 visible in FIG. 7, oriented substantially horizontally. This orients the pole P substantially vertically, as shown in FIG. 7, to facilitate maneuvering the end loader E without the length of the pole P extending outwardly therefrom. This also orients the pole P properly for vertical installation in the ground, e.g., as a support for a pole building, fence or barrier, etc. It will be seen that the above described steps and procedure may be reversed for the removal of a pole P or the like from a site where it was previously installed.

The height of the pole P is adjusted as required relative to the apparatus 10 by means of the bucket lift arms A of the end loader E. If a greater portion of the pole P must extend beneath the pole-handling attachment 10 than as shown in FIG. 5 through 7, the pole P may be oriented vertically as shown in FIG. 7 and lowered to rest upon the underlying surface. The slide assembly 20 may then be loosened slightly from its grip on the pole P, and the pole-handling attachment 10 slid up the pole by raising it with the lift arms A to a new location or position along the pole. The slide 20 is then actuated to close upon the pole P, securely clamping the pole P between the slide assembly 20 and opposite clamp end 16 at a new location along the pole. It will be seen that this maneuver may be accomplished with the pole P resting upon the surface as well, but the position of the proximate end of the pole P may be limited by the structure of the end loader in such a maneuver.

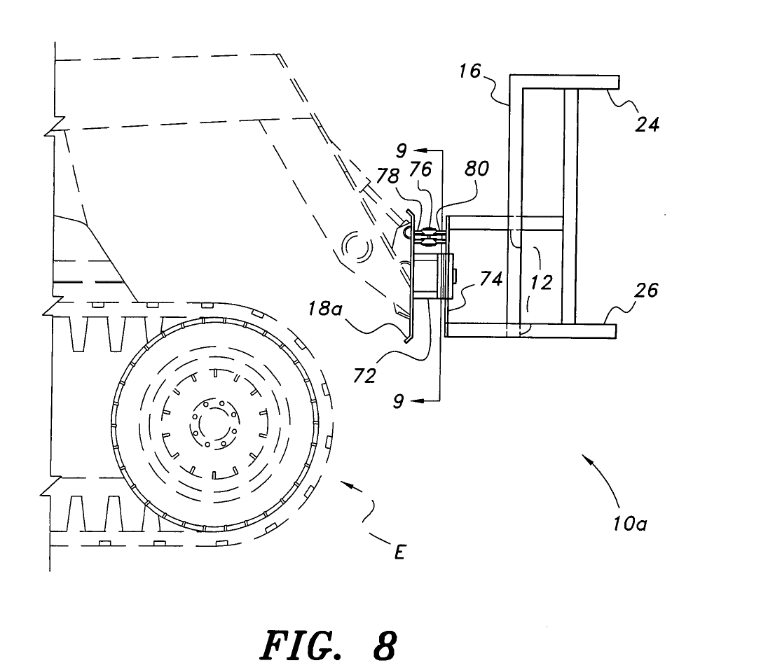

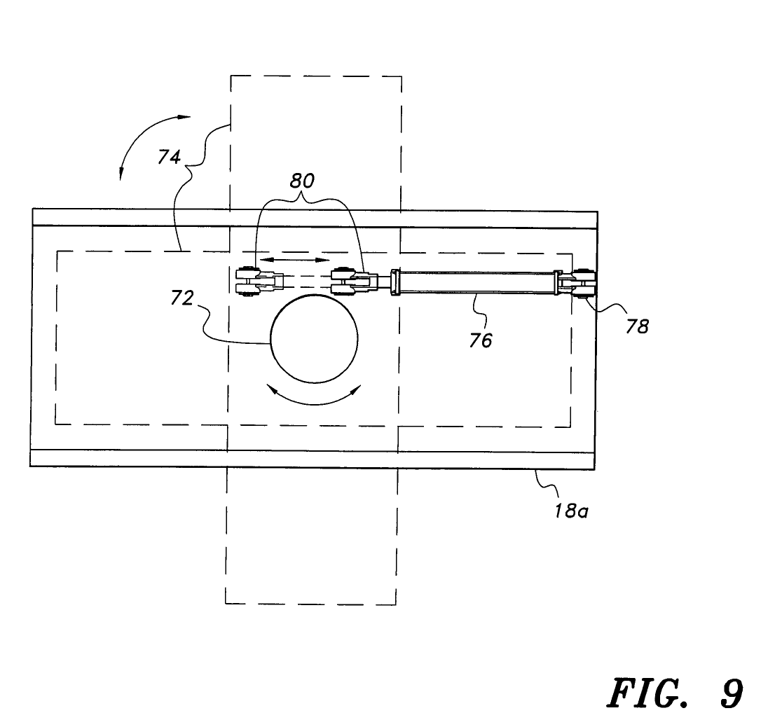

FIGS. 8 and 9 of the drawings are respectively a right side elevation view and a front elevation view of an alternative embodiment of the pole-handling attachment in which the attachment incorporates a rotary bearing allowing the pole-grasping portion of the device to be rotated to various orientations and an actuator to provide power actuation of such rotation. The device of FIGS. 8 and 9 is designated as pole-handling attachment 10a.

The pole-handling attachment 10a includes an end loader attachment plate 18a, similar to the attachment plate 18 of the embodiment 10 of FIGS. 1 through 7. The attachment plate 18a is removably secured to the conventional bucket attachment mechanism of the end loader E in a manner familiar to those knowledgeable in the art. However, rather than the actuator end and clamp end structures and base frame attaching directly to the attachment plate 18a, the attachment plate 18a has a rotary bearing 72 extending generally centrally therefrom and opposite the attachment surface thereof. The bearing 72 has a rotary axis substantially normal to the plane of the plate 18a. A rotary plate 74 is attached to the bearing 72 opposite the attachment plate 18a, with the base frame 12 of the attachment 10a separated therefrom by the actuator end and clamp end structures. The clamp end frame structure 16 and its first and second clamp end arms 24 and 26 are shown in the right side elevation view of FIG. 8.

FIG. 9 provides a front elevation view of the above described assembly along line 9-9 of FIG. 8. A powered actuator 76 (e.g., hydraulic strut, electrically or hydraulically powered jack screw, etc.) is installed between the end loader attachment plate 18a and the rotary plate 74. An attachment plate link or anchor 78 secures one end of the actuator 76 to the attachment plate 18a, and a rotary plate link or anchor 80 secures the opposite end of the actuator 76 to the rotary plate 74. Thus, when the actuator 76 is extended, the rotary plate 74 is forced to rotate relative to the end loader attachment plate 18a, thus rotating the remainder of the structure (e.g., the clamp end 16 with its arms 24 and 26, the base frame members 12, etc.) relative to the end loader attachment plate 18a. Thus, when the pole-handling attachment 10a is oriented as shown in FIGS. 8 and 9, a pole being held by the device can be rotated through a substantially 90° arc with its axis generally normal to the plane of the attachment plate 18a, rotary plate 74, and base frame members 12. Greater rotation may be achieved by means of a different type of powered actuator, e.g., an electric or hydraulic motor in combination with the rotary bearing 72.

In conclusion, the pole-handling attachment greatly facilitates the manipulating, handling, and limited transport of single poles, posts, columns, and similar elongate articles in and around construction sites, storage yards, etc. When using the pole-handling attachment with a compatible end loader machine, a single operator can pick up, manipulate, maneuver, and place a large and/or heavy pole, post, or column, without need for additional help. The procedure is easily reversed for the removal of a pole, post, or column from an installation site. The device is quickly and easily installed and removed from the conventional bucket attachment of an end loader machine, and a single person may accomplish the installation and removal without recourse to outside help. Accordingly, the pole-handling attachment will prove to be a most valuable piece of equipment for those who have occasion to work with poles, posts, and columns from time to time.

It is to be understood that the present invention is not limited to the embodiments described above, but encompasses any and all embodiments within the scope of the following claims.

I claim:

1. A pole-handling attachment for an end loader, comprising:
a substantially rectangular base frame having an actuator end and a clamp end opposite the actuator end, the base frame being adapted for attachment to the end loader in lieu of a bucket;
an actuator end assembly extending from the actuator end of the base frame, substantially normal thereto;
a clamp end assembly extending from the clamp end of the base frame substantially normal thereto, the clamp end assembly having mutually opposed, spaced apart, substantially parallel first and second clamp arms;
a slide assembly adjustably disposed upon the base frame between the actuator end and the clamp end thereof, the slide assembly having mutually opposed, spaced apart, substantially parallel first and second slide arms, the slide arms being substantially parallel to the clamp arms of the clamp end assembly, the clamp arms and the slide arms defining an adjustable pole-clamping zone therebetween; and
a powered linear actuator adjustably disposed between the actuator end assembly and the slide assembly, selectively positioning the slide assembly and slide arms relative to the clamp end assembly and clamp arms in order to clamp a pole between the slide assembly and the clamp end assembly.

2. The pole-handling attachment according to claim 1 further including an end loader machine, the base frame being removably secured thereto.

3. The pole-handling attachment according to claim 1, further including:
an end loader attachment plate for attaching the base frame to the end loader;
a rotary bearing disposed between the end loader attachment plate and the base frame, the bearing defining a rotational axis for the base frame relative to the attachment plate normal to the attachment plate and base frame; and
a powered actuator selectively rotating the base frame relative to the attachment plate.

4. The pole-handling attachment according to claim 1, further including a telescopically adjustable extension tine removably disposed within each of the clamp arms and slide arms.

5. The pole-handling attachment according to claim 4, wherein each said extension tine further has a distal end, the attachment further comprising a pole-grasping shoe disposed across the distal end of each said extension tine.

6. The pole-handling attachment according to claim 1, further including an extension link removably disposed between the linear actuator and the slide assembly.

7. The pole-handling attachment according to claim 1, further including an unbalanced pole brace arm extending from the base frame between the actuator end assembly and the slide assembly.

8. An end loader and pole-handling attachment therefor, comprising in combination:
a powered end loader machine having a powered, adjustably positionable means for attaching a bucket thereto;
a substantially rectangular base frame having an actuator end and a clamp end opposite the actuator end, removably secured to the bucket attaching means of the end loader machine;
an actuator end assembly extending from the actuator end of the base frame, substantially normal thereto;
a clamp end assembly extending from the clamp end of the base frame substantially normal thereto, the clamp end assembly having mutually opposed, spaced apart, substantially parallel first and second clamp arms;
a slide assembly adjustably disposed upon the base frame between the actuator end and the clamp end thereof, the slide assembly having mutually opposed, spaced apart, substantially parallel first and second slide arms, the slide arms being substantially parallel to the clamp arms of the clamp end assembly, the clamp arms and the slide arms defining an adjustable pole clamping zone therebetween; and
a powered linear actuator adjustably disposed between the actuator end assembly and the slide assembly, selectively positioning the slide assembly and slide arms relative to the clamp end assembly and clamp arms in order to clamp a pole between the slide assembly and the clamp end assembly.

9. The end loader and pole-handling attachment combination according to claim 8, further including:
an end loader attachment plate disposed between the bucket attaching means of the end loader machine and the base frame of the pole-handling attachment;
a rotary bearing disposed between the end loader attachment plate and the base frame, the bearing defining a rotational axis for the base frame relative to the attachment plate normal to the attachment plate and base frame; and
a powered actuator selectively rotating the base frame relative to the attachment plate.

10. The end loader and pole-handling attachment combination according to claim 8, further including a telescopically adjustable extension tine removably disposed within each of the clamp arms and slide arms.

11. The end loader and pole-handling attachment combination according to claim 10, wherein each said extension tine has a distal end, the combination further comprising a pole-grasping shoe disposed across the distal end of each said extension tine.

12. The end loader and pole-handling attachment combination according to claim 8, further including an extension link removably disposed between the linear actuator and the slide assembly.

13. The end loader and pole-handling attachment combination according to claim 8, further including an unbalanced pole brace arm extending from the base frame between the actuator end assembly and the slide assembly.

14. A pole-handling attachment for an end loader, comprising:
an end loader attachment plate adapted for attachment to the end loader;
a substantially rectangular base frame having an actuator end and a clamp end opposite the actuator end;
a rotary bearing disposed between the end loader attachment plate and the base frame, the bearing defining a rotational axis for the base frame relative to the attachment plate normal to the attachment plate and base frame;
a powered actuator selectively rotating the base frame relative to the attachment plate;
an actuator end assembly extending from the actuator end of the base frame, substantially normal thereto;
a clamp end assembly extending from the clamp end of the base frame substantially normal thereto, the clamp end assembly having mutually opposed, spaced apart, substantially parallel first and second clamp arms;
a slide assembly adjustably disposed upon the base frame between the actuator end and the clamp end thereof, the slide assembly having mutually opposed, spaced apart, substantially parallel first and second slide arms, the slide arms being substantially parallel to the clamp arms of the clamp end assembly, the clamp arms and the slide arms defining an adjustable pole-clamping zone therebetween; and
a powered linear actuator adjustably disposed between the actuator end assembly and the slide assembly, selectively positioning the slide assembly and slide arms relative to the clamp end assembly and-clamp arms in order to clamp a pole between the slide assembly and the clamp end assembly.

15. The pole-handling attachment according to claim 14 further including an end loader machine, the end loader attachment plate being removably secured thereto.

16. The pole-handling attachment according to claim 14, further including a telescopically adjustable extension tine removably disposed within each of the clamp arms and slide arms of the base frame.

17. The pole-handling attachment according to claim 16, wherein each said extension tine has a distal end, a pole-grasping shoe disposed across the distal end of each said extension tine.

18. The pole-handling attachment according to claim 14, further including an extension link removably disposed between the linear actuator and the slide assembly of the base frame.

19. The pole-handling attachment according to claim 14, further including an unbalanced pole brace arm extending from the base frame between the actuator end assembly and the slide assembly.
